(19) United States
(12) Patent Application Publication
(10) Pub. No.: US 2010/0295871 A1
(43) Pub. Date: Nov. 25, 2010

(54) SYSTEMS AND METHODS FOR MAGNIFYING DISPLAY ELEMENTS

(76) Inventor: Umang Dua, Georgetown (CA)

Correspondence Address: Umang Dua, 18 Grist Mill Dr., Georgetown, ON, L7G 6C2, CA

(21) Appl. No.: 12/775,786

(22) Filed: May 7, 2010

Related U.S. Application Data
(60) Provisional application No. 61/216,627, filed on May 20, 2009.

(51) Int. Cl. G09G 5/00

(52) U.S. Cl. 345/660

(57) ABSTRACT

Systems and methods for magnifying screen elements for display are provided. A screen magnification tool to scale the content of a computer display screen by rendering elements which were meant to be rendered at the original size at a larger size, so that the final enlarged output is more legible.

### CROSS-REFERENCE TO RELATED APPLICATION

This claims the benefit of U.S. Provisional Patent App. Ser. No. 61/216,627, filed May 20, 2009, the disclosure of which is hereby incorporated by reference herein in its entirety.

### BACKGROUND OF THE DISCLOSURE

This invention relates generally to the display of screen elements, and more particularly, to the magnification of screen elements for display.

Displays, such as computer, telephone, and PDA displays, may come in a wide variety of shapes and sizes. These displays may be used to present a wide range of textual and graphical information. In some cases, an array of picture elements, or pixels, may be used to present the information on the display. A pixel may represent a single point in a raster image and may be the smallest addressable screen element that can be controlled. Each pixel may be associated with a fixed location on the display and may be addressed using coordinates.

A technique known as rasterization is often used to take an image described in a vector graphics format (e.g., shapes, such as lines and curves) and convert that image into a raster image (e.g., pixels or dots) for presentation on a display (or for storage in a image file format or for printing). It is often difficult, however, to rasterize an image in such a way that pixels lying precisely on the intended path of a line or curve are selected for activation. Rather, one or more of the nearest pixels are generally selected for activation and an anti-aliasing technique may be used to improve the overall appearance of the image.

The activation of pixels off the true path of a line or curve may result in a rasterized image that includes slight errors or distortions. These errors or distortions may appear insignificant or inconspicuous sometimes, but when the rasterized image is magnified or enlarged each activated pixel is typically magnified and then a portion of the magnified image is re-sampled to obtain new pixel values for display. This technique may magnify the rasterization errors, resulting in pixelation and illegible text or graphics.

Accordingly, it would be desirable to provide systems and methods for presenting renderable elements in a magnified or enlarged state more legibly and with less pixelation.

### SUMMARY OF THE DISCLOSURE

In accordance with the principles of the present invention, systems and methods are provided for magnifying or enlarging screen elements for display. A request to magnify or enlarge an area of a display may be received. A “viewport” area to be enlarged may be defined by a user using a magnification tool. For example, the user may define a rectangle (or any other shape) as the viewport area.

A determination may then be made that content in the viewport area has changed. For example, new content may appear on the screen in the viewport area or the user may have redefined the viewport area by moving or panning the viewport window. Parameters used to enlarge the viewport may then be received, and a zoom image (e.g., a zoom bitmap) created by stretching display elements to be enlarged. In some embodiments, the zoom image may be processed by one or more image smoothing techniques (for example, one or more anti-aliasing techniques) which may smooth the enlarged display elements to improve legibility. A repaint request may then be issued and one or more elements may be redrawn in the zoom image. The zoom image may then be displayed, saved (e.g., stored in a buffer or to local storage), or sent as output (e.g., to a printer or other output device).

In some embodiments a display command may be intercepted by an interception code. In response to intercepting the display command, at least one display parameter describing a desired modification to a display area of a display screen may be accessed. The display area may include a plurality of display elements, such as text, shapes, graphics, or any other suitable elements. At least one display element of the plurality of display elements may be identified to be enlarged. Enlargement parameters may be calculated for each identified display element based at least in part on the accessed display parameter. An enlarged version of each identified display element may be rendered in a zoom image, and the zoom image may be displayed on a display screen (or output to an output device).

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a diagram of a character displayed in enlarged sizes in accordance with one embodiment of the invention;

FIG. 2 shows an illustrative system for producing an image for display in accordance with one embodiment of the invention;

FIGS. 3A and 3B show an illustrative process for enlarging a display area in accordance with one embodiment of the invention; and

FIG. 4 is an illustrative diagram of a shifted viewport location in accordance with one embodiment of the invention.

### DETAILED DESCRIPTION

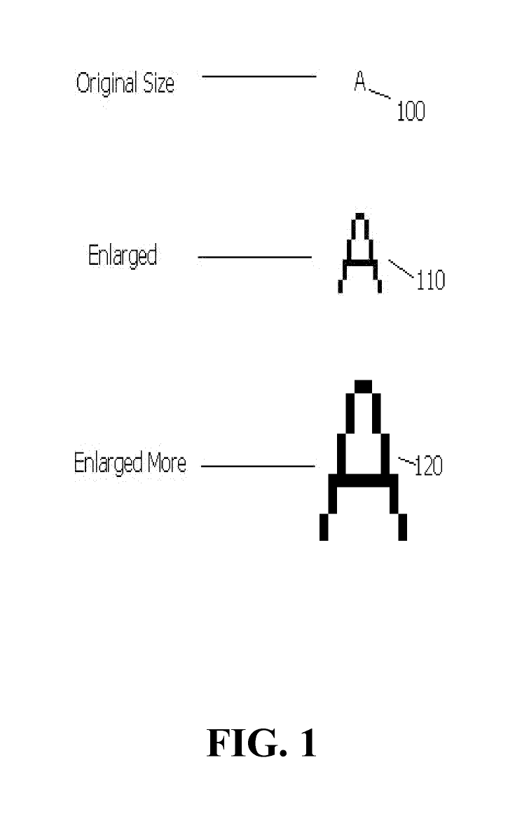

FIG. 1 shows a character, which is displayed at its original size 100. The character may have been rasterized onto a display by altering the pixels located on the display. The character at size 100 appears relatively legible. The same character is displayed in enlarged size 110 via traditional magnification methods. As shown in FIG. 1, the individual pixels become visible at enlarged size 110, causing poor legibility of the character. At an even larger size 120, the character is suffering from severe pixelation as a result of the magnification, making it very difficult to read. In FIG. 1, pixelation may occur because each pixel of the area to be enlarged is mapped onto multiple pixels of the enlarged display. This may result in poor legibility because rasterizing errors which are inconspicuous at a smaller size may become more pronounced at larger sizes.

Although some embodiments described herein may refer to a display or a display screen, the present invention may also be used for other forms of image presentation or image processing. For example, instead of displaying the enlarged image, the image may be buffered in memory or saved to a local or network storage device. Additionally or alternatively, the enlarged image may be sent as output to a printer or other output device. Displays or display screens may include computer displays (e.g., CRT, LCD, or plasma displays), television displays, telephone displays, PDA displays, any other suitable displays, or any suitable combination of displays.

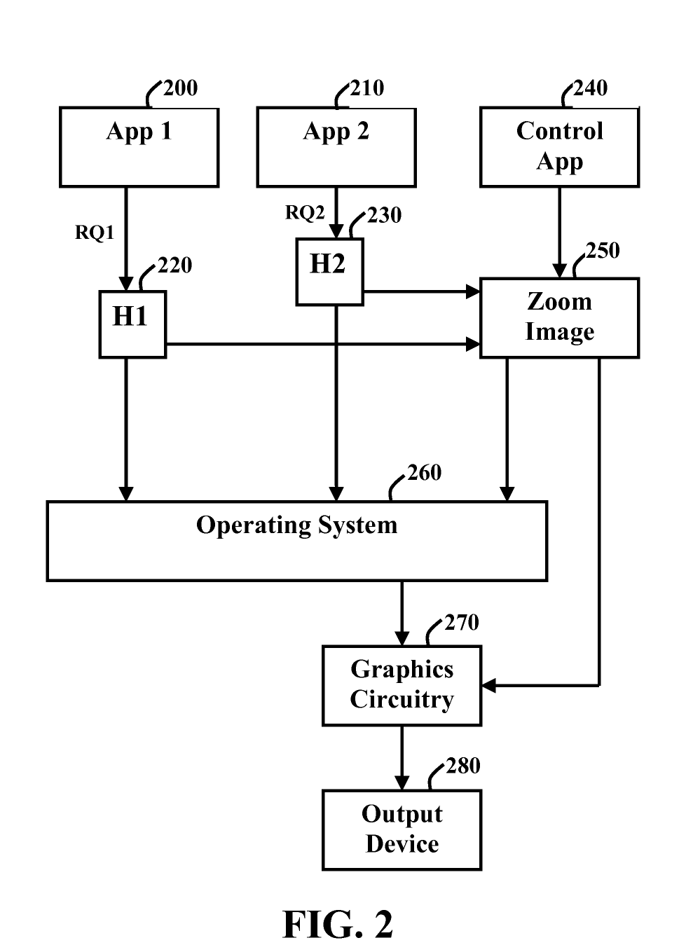

FIG. 2 shows a system for producing an image for output according to one embodiment of the invention. Application programs 200 and 210 may issue requests RQ1 and RQ2 to draw renderable elements on a display screen (or otherwise output the elements, for example, to a printer). These requests may correspond to one or more display commands. For example, requests RQ1 and RQ2 may include one or more draw character commands, draw line commands, draw shape commands, or any combination of the foregoing. In the illustrated embodiment, the requests may be issued to operating system 260, but one or more of requests RQ1 and RQ2 (and their associated commands) may be intercepted by one or more of third-party codes (also referred to herein as “interception code”) 220 and 230. In some embodiments, interception codes 220 and/or 230 may be implemented through the use of a technique known as API hooking. API hooking may not require administrative (or elevated) privileges or installation on some operating system platforms (e.g., the MS Windows platform). This may allow control application 240 to gather information needed to enlarge the renderable elements without, for example, any installation, with improved legibility, and with complete portability (for example, control application 240 may run from a USB drive, CDROM, via the Internet, floppy disk, or any other machine-readable medium without installation). For example, an operating system API hook (e.g., a Win32 API hook) may be used to monitor drawing-related function calls issued to or by operating system 260.

In some embodiments, function interception mechanisms may be used, such as a mirror driver, video intercept driver, driver chain manager, or any other function interception mechanism, which may allow an application program (such as control application 240) to intercept function calls being made to the operating system (such as operating system 260). Interception code 220 and/or 230 may render an enlarged version of a desired display element (such as a text character, a line, a circle, a rectangle, Bezier curve, ellipse or any other renderable entity) after intercepting the original requests RQ1 and RQ2 onto zoom image 250. Parameters indicated by control application 240 may be used to determine magnification preferences. Such preferences may include, for example, information such as the magnification level, color preferences, and viewport location. Thus, zoom image 250 may include elements which are more legible than would have been possible using traditional magnification techniques.

Graphics circuitry 270 may process zoom image 250 for display, buffering, storage, or output to another device (e.g., a printer). Graphics circuitry 270 may include memory (e.g., RAM, ROM, and hybrid types of memory), one or more graphics processors (including, for example, digital signal processing circuitry), and scaling circuitry to process zoom image 250. Zoom image 250 may be passed to graphics circuitry 270 via operating system 260. Additionally or alternatively, graphics circuitry 270 may access zoom image 250 directly from memory (e.g., bypassing operating system 260). Graphics circuitry 270 may be connected to output device 280, which may include any type of image presentation or processing mechanism, including, for example, a display device, a printer, or a projector.

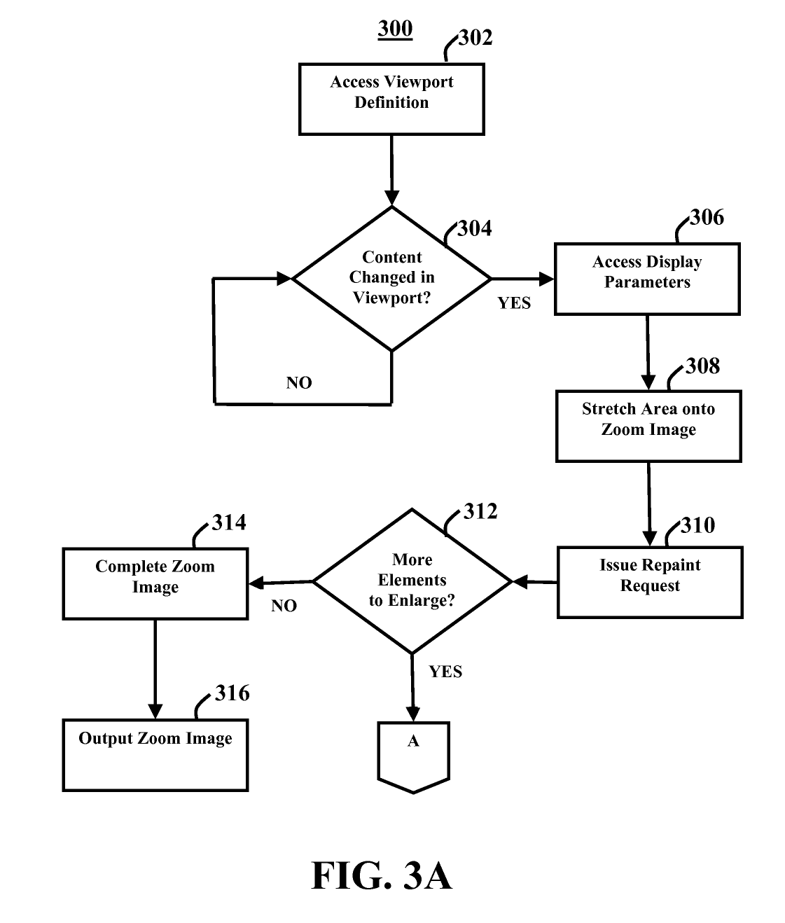

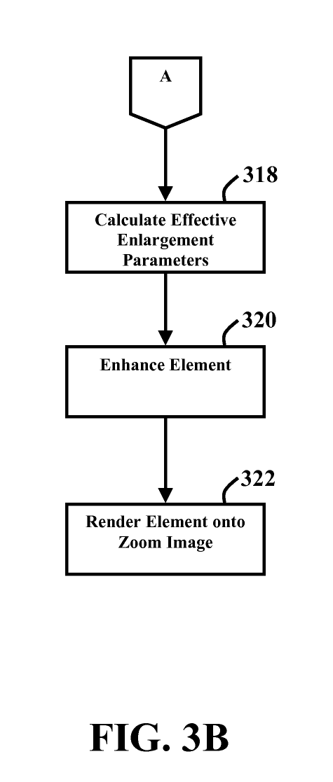

FIGS. 3A and 3B show illustrative process 300 for enlarging screen elements in a zoom area or viewport. First, control application 240 (FIG. 2) or operating system 260 (FIG. 2) may access a viewport definition at step 302. For example, a user may utilize application 200, application 210, or control application 240 (all of FIG. 2) to define a zoom area. The zoom area may be represented by absolute coordinates on a screen or other display mechanism. For example, in some embodiments, the viewport may include a rectangular region defined by a zoom utility or tool executing on operating system 260 (FIG. 2).

At step 304, control application 240 (FIG. 2) may determine if the content of the viewport has changed. This may include changes such as new content appearing on the screen or new content appearing within the viewport as a result of moving the viewport location. The changes may be detected, in some embodiments, by detecting changed pixels between the last snapshot and current snapshot of the content on the screen or viewport. Snapshots may be created through any screen capture mechanism. Changes may additionally or alternatively be detected through detecting certain events fired on the system. One event which often results in content changing on the screen is the WM_PAINT message used in MS Windows based operating systems. Such messages may be detected to determine the content which may have changed on the screen. Other methods of detecting on-screen changes may include using video drivers, mirror drivers, driver chaining managers, which generate events to indicate content which may have changed on the screen. In some embodiments, step 304 may be eliminated or replaced by a polling mechanism. Such a polling mechanism may simply repeat the steps used to create the magnified content at certain intervals without detecting changes in the viewport content.

The system may then obtain the necessary parameters to magnify the viewport at step 306. Such parameters may comprise the zoom level, color enhancements, viewport location, and any other information necessary to scale some or all of the content of the viewport. The viewport area may then enlarged or stretched at step 308 onto the zoom image. The viewport content may be obtained by one or more of a variety of techniques such as, but not limited to, GDI screen capture, intercepting the drawing commands to the operating system, DirectX screen capture, accessing the video frame buffer, Windows Media Player screen capture API, any other screen capture mechanism, or any combination of the foregoing. In some embodiments, the enlargement at step 308 may occur through the use of functions such as StretchBlt in the MS Windows based operating systems. Other stretching algorithms may be used in other embodiments.

In some embodiments, the stretching may include image smoothing algorithms (e.g., anti-aliasing) which may smooth the enlarged pixels to improve legibility. In some embodiments, only the changed content determined at step 304 may be stretched instead of stretching the entire content of the viewport. After the zoom image holds the enlarged content, the renderable elements (such as circles, text, lines, ellipses, rectangles) may be drawn at an enlarged size onto the zoom image. Information about which elements are to be redrawn may be obtained by issuing a repaint command at step 310. The repaint command may be issued to the operating system (e.g., operating system 260 (FIG. 2)), and/or to the windows in the area to be repainted and/or to other objects which would result in re-drawing some or all of the elements of the screen. When the elements need to be rendered by their respective applications, the rendering commands may be issued to the operating system. Some examples of such commands may be TextOut, ExtTextOut, Rectangle, Ellipse, Polygon, but any function call which may result in renderable elements being rasterized may also be used. These calls may be intercepted or received through the use of interception code (e.g., codes 220 or 230 (FIG. 2)) by an application other than the operating system in some embodiments.

At step 312, a determination is made whether there are more elements to enlarge (e.g., more renderable elements). If so, illustrative process 300 may continue in FIG. 3B. For each element to be enlarged, effective enlargement parameters may be calculated at step 318. The enlargement parameters may be used to render an enlarged version of each respective element onto the zoom image. The enlargement parameters may include, for example, the viewport location, magnification level, color transformations, or any other suitable parameters. At step 320, the renderable element may be enhanced, for example, using anti-aliasing techniques. At step 322, the element may be rendered onto the zoom image. After the zoom image has the some or all of the enlarged elements rendered onto it, the zoom image may be rendered complete at step 314. The zoom image may then be output to an output device (e.g., display screen) at step 316.

In some embodiments, the zoom image may be a separate area in disk or memory where the magnified image is prepared and then presented to the viewer after being completed. In some embodiments, the zoom image may be the area being viewed by the user directly. The zoom image may also hold the enlarged pixilated versions of the renderable elements after enlarging an area of the viewport onto the zoom image at step 308. In such circumstances, the pixilated versions of the enlarged elements may be removed prior to rendering the enlarged versions of the elements onto the zoom image. This may be accomplished by erasing the enlarged pixilated versions of the elements with the background color, a color similar to the background color, or any other mechanism which produces the effect of erasing the enlarged pixilated element. In some embodiments, the original renderable element may never be drawn so that no erasing of the enlarged pixilated element is necessary. This may be accomplished by preventing drawing commands from reaching the operating system or by altering the drawing commands to the operating system so that the rendered element is drawn differently from what was originally intended.

For example, if the text “Hello” is to be drawn through the function ExtTextOut, a text length of 0 may be passed to the operating system instead of the original text length of 5. This may result in nothing being drawn even though the drawing command was issued to the operating system. One example of preventing drawing commands from reaching the operating system may include the interception code returning without issuing the respective drawing command to the operating system. In some embodiments, the non-magnified renderable element or elements may be erased prior to enlarging the viewport onto the zoom image. This may have the same effect as erasing the pixilated enlarged renderable elements.

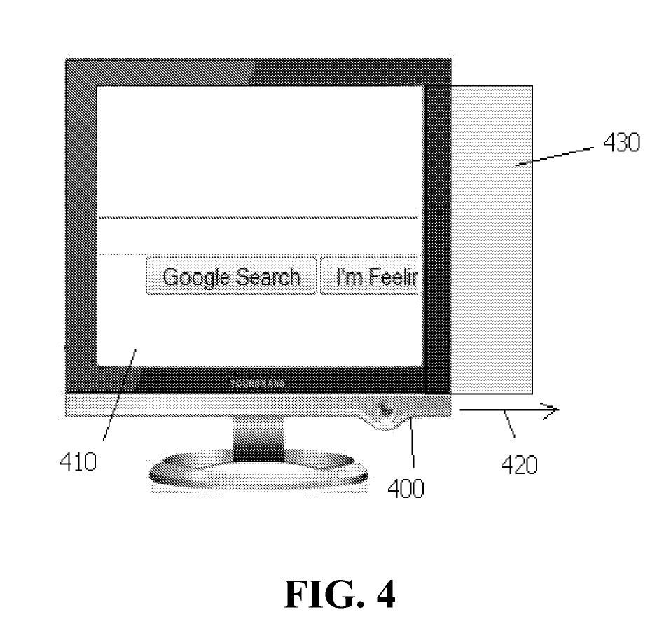

FIG. 4 shows illustrates the effect of scrolling viewport 420 to the right. As viewport 420 is moved to the right of its current location, new content 430 which is currently invisible on display screen 400 may need to be magnified and shown to the user. In order to redraw the renderable elements, repaint request(s) may be issued which may cause some or all of the running applications to issue drawing commands. As the drawing commands are issued, these commands may be detected and intercepted (e.g., by interception code 220 and/or 230). Enlarged versions of those elements may be rendered on the zoom image at their respective locations, resulting in more legible magnified output.

In some embodiments, a machine-readable medium includes machine-readable instructions which causes a processor to perform some or all of the operations described above. In other embodiments, the operations may be performed by specific hardware components that contain hardwired logic. Those operations may alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROMs), Read-Only Memory (ROMs), Random Access Memory (RAM), Erasable Programmable Read-Only Memory (EPROM), and a transmission over the Internet.

One skilled in the art will appreciate that the invention can be practiced by other than the prescribed embodiments, which are presented for purposes of illustration and not of limitation, and the invention is limited only by the claims which follow.

What is claimed is:

1. A method for magnifying display elements comprising:
intercepting a display command;
in response to intercepting the display command, accessing at least one display parameter describing a desired modification to a display area of a display screen, the display area comprising at least one display element;
calculating enlargement parameters for at least one display element based at least in part on the display parameter;
rendering an enlarged version of at least one display element on a zoom image; and
displaying the zoom image on the display screen.

2. The method of claim 1 wherein intercepting a display command comprises intercepting a display command selected from the group consisting of a draw character display command, a draw line display command, and a draw shape display command.

3. The method of claim 1 wherein intercepting a display command comprises monitoring drawing commands using an API hook.

4. The method of claim 1 wherein at least one display element is not rendered.

5. The method of claim 1 wherein at least one display element is rendered with parameters other than the original display command parameters.

6. The method of claim 1 comprises determining if content in the display area has changed.

7. The method of claim 5 wherein determining if content in the display area has changed comprises comparing a snapshot of the display area with a prior snapshot.

8. The method of claim 5 wherein determining if content in the display area has changed comprises detecting a system event.

9. The method of claim 1 wherein rendering an enlarged version of at least one display element in a zoom image comprises:
erasing at least one display element with a color substantially similar to a background color of the display element; and
redrawing at least one display element on the zoom image.

10. A system for magnifying display elements comprising:
a display device; and
a processor configured to:
intercept a display command;
in response to intercepting the display command, access at least one display parameter describing a desired modification to a display area of a display screen, the display area comprising at least one display element;
calculate enlargement parameters for at least one display element based at least in part on the display parameter;
render an enlarged version of at least one display element in a zoom image; and
display the zoom image on the display device.

11. The system of claim 10 wherein the processor is configured to intercept a display command by intercepting a display command selected from the group consisting of a draw character display command, a draw line display command, and a draw shape display command.

12. The system of claim 10 wherein the processor is configured to intercept a display command by monitoring drawing commands using an API hook.

13. The system of claim 10 wherein the processor is further configured to not render at least one of the display elements.

14. The system of claim 10 wherein the processor is further configured to render at least one of the display elements with parameters other than the at least one display parameter.

15. The system of claim 10 wherein the processor is configured to determine if content in the display area has changed.

16. The system of claim 14 wherein the processor is configured to compare a snapshot of the display area with a prior snapshot.

17. The system of claim 14 wherein the processor is configured to determine if content in the display area has changed by detecting a system event.

18. The system of claim 10 wherein the processor is configured to render an enlarged version of at least one display element in a zoom image by:
erasing at least one display element with a color substantially similar to a background color of the display element; and
redrawing at least one display element on the zoom image.

19. A machine-readable medium with machine-readable instructions encoded thereon that, when executed by a processor, cause the processor to perform operations comprising:
intercepting a display command;
in response to intercepting the display command, accessing at least one display parameter describing a desired modification to a display area of a display screen, the display area comprising at least one display element;
calculating enlargement parameters for at least one display element based at least in part on the display parameter;
rendering an enlarged version of at least one display element in a zoom image; and
displaying the zoom image on the display screen.

20. The machine-readable medium of claim 19 wherein intercepting a display command comprises monitoring drawing commands using an API hook.
